(19) United States
(12) Patent Application Publication
(10) Pub. No.: US 2009/0207386 A1
(43) Pub. Date: Aug. 20, 2009

(54) PORTABLE ELECTRONIC DEVICE WITH PROJECTION FUNCTIONALITY

(76) Inventors: You-Chi LIU, Neihu (TW); Ming-Chung Peng, Neihu (TW); Wen-Yi Chiu, Neihu (TW)

Correspondence Address: Muncy, Geissler, Olds & Lowe, PLLC, P.O. BOX 1364, FAIRFAX, VA, 22038-1364, US

(21) Appl. No.: 12/259,734

(22) Filed: Oct. 28, 2008

(30) Foreign Application Priority Data
Feb. 15, 2008 (TW) 97105366

(51) Int. Cl. G03B 21/00

(52) U.S. Cl. 353/119

(57) ABSTRACT

A portable electronic device includes a body portion, a display portion, a projection module and a knob. The body portion has a hollow housing including two immediately-adjacent housing walls, and each of the two housing walls has a projection window. The display portion is pivotally connected with the hollow housing. The projection module is rotatably connected to and within the hollow housing and has a projection head for projecting an image. The knob is rotatably connected on an outer support surface of the hollow housing and connected to the projection module, whereby the knob is operable to rotate the projection head to selectively align with one of the two projection windows.

### RELATED APPLICATIONS

This application claims priority to Taiwan Application Serial Number 97105366, filed Feb. 15, 2008, which are herein incorporated by reference.

### BACKGROUND

1. Field of Invention

The present invention relates to an image projection device.

2. Description of Related Art

Conventionally, a presentation may be executed by using a notebook computer and a projector electrically coupled with the notebook computer such that what is displayed on a screen of the notebook computer can be projected on a relatively big screen. Unless the conference room is equipped with the projector, a presenter needs to carry at least a notebook computer and a projector in order to present the content previously stored in the notebook computer. It is somewhat inconvenient for the presenter to do so.

### SUMMARY

It is therefore an objective of the present invention to provide a portable electronic device equipped with image projection functionality.

In accordance with the foregoing and other objectives of the present invention, an image projector includes a body portion, a projection module and a knob. The body portion has a hollow housing including two immediately-adjacent housing walls, each of the two housing walls having a projection window. The projection module is rotatably connected to and within the hollow housing and has a projection head for projecting an image. The knob is rotatably connected on an outer support surface of the hollow housing and connected to the projection module, whereby the knob is operable to rotate the projection head to selectively align with one of the two projection windows.

In accordance with the foregoing and other objectives of the present invention, a portable electronic device includes a body portion, a display portion, a projection module and a knob. The body portion has a hollowing housing including two immediately-adjacent housing walls, and each of the two housing walls has a projection window. The display portion is pivotally connected with the hollow housing. The projection module is rotatably connected to and within the hollow housing and has a projection head for projecting an image. The knob is rotatably connected on an outer support surface of the hollow housing and connected to the projection module, whereby the knob is operable to rotate the projection head to selectively align with one of the two projection windows.

Thus, the present invention provides a portable electronic device with projection function such that a presenter can perform a presentation without carrying an extra projector. In addition, the projection direction and angle can be adjusted towards a desired one so as to achieve an optimum projection effect.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a side view of a portable electronic device according to one preferred embodiment of this invention;

FIG. 2 illustrates a bottom view of a portable electronic device according to one preferred embodiment of this invention;

FIG. 3 illustrates a series of views for switch a projection direction of the portable electronic device;

FIG. 4 illustrates an exploded view of the knob as illustrated in FIG. 3;

FIG. 5 and FIG. 6 respectively illustrate two different projection modes of a portable electronic device according to one preferred embodiment of this invention; and

FIG. 7 illustrates an exploded view of a projection module within the portable electronic device.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

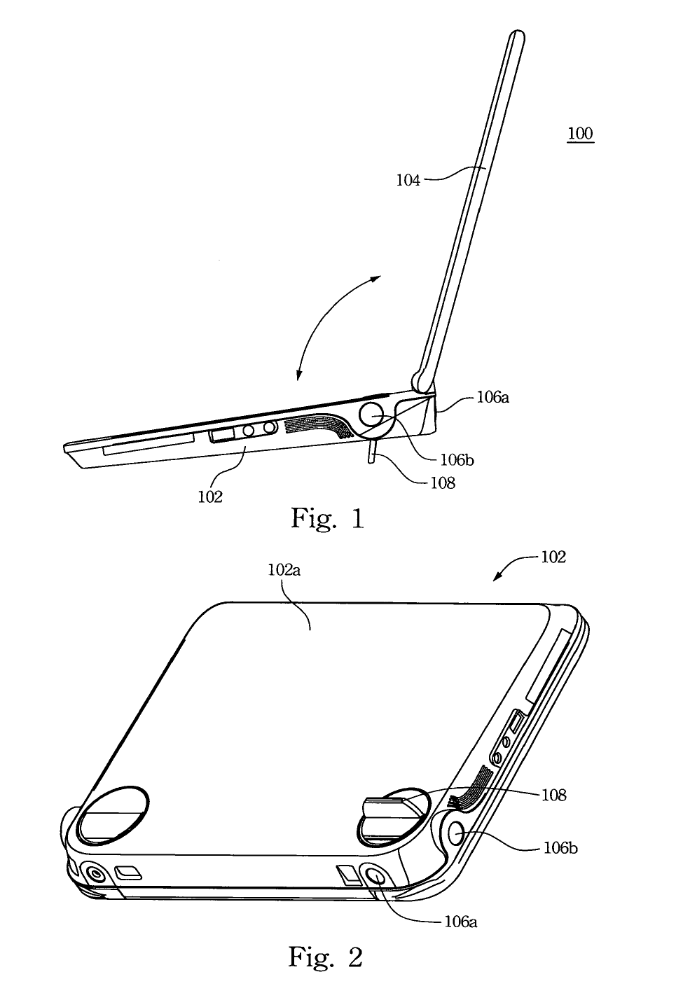

FIG. 1 illustrates a side view of a portable electronic device according to one preferred embodiment of this invention. A portable electronic device 100 includes a body portion 102 and a display portion 104. The portable electronic device 100 is equipped with an image projection function, which serves to project what is displayed on the display portion 104 through projection windows 106a or 106b. The display portion 104 is pivotally connected with the body portion 102 such that the display portion 104 can be swiveled relative to the body portion 102. The display portion 104 can be selectively laid against the body portion 102 or an included angle is formed between the display portion 104 and the body portion 102. In addition, the portable electronic device 100 includes a handle member 108 to support the body portion 102 to various inclined gradients so as to adjust projection angle, i.e. the handle member 108 lifts one side of the body portion 102 to a desired height.

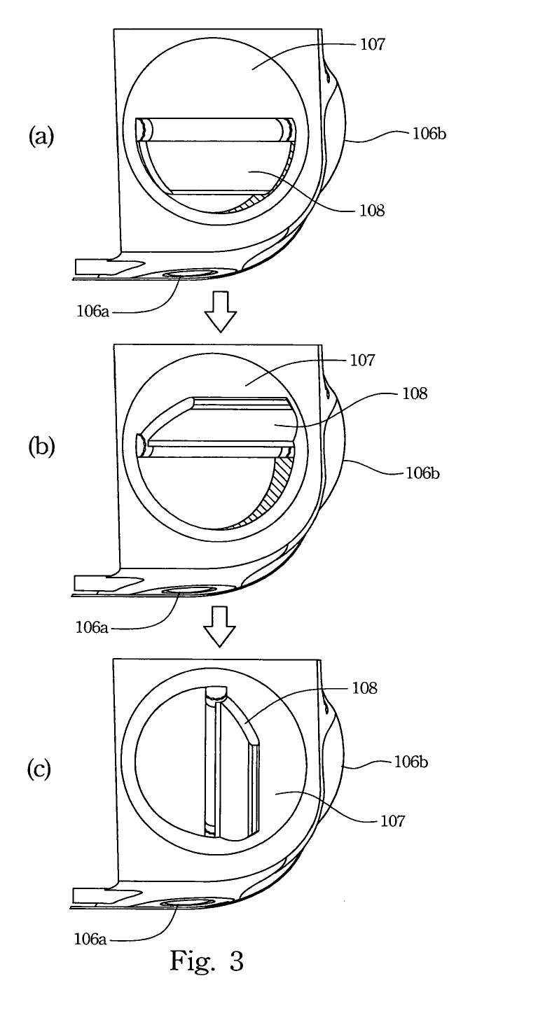

FIG. 2 illustrates a bottom view of a portable electronic device as illustrated in FIG. 1. The handle member 108 on an outer support surface 102a (or referred as a bottom surface) also serves to switch projection direction. In particular, the handle member 108 may be operable to selectively project an image through the projection window 106a or the projection window 106b. Referring to FIG. 3, the projection direction in view (a) is along the projection window 106b, the handle member 108 is swiveled upright relative to the disk member 107 in view (b), and the projection direction in view (c) is along the projection window 106a after rotating the handle member 108 in view (a) by 90 degrees.

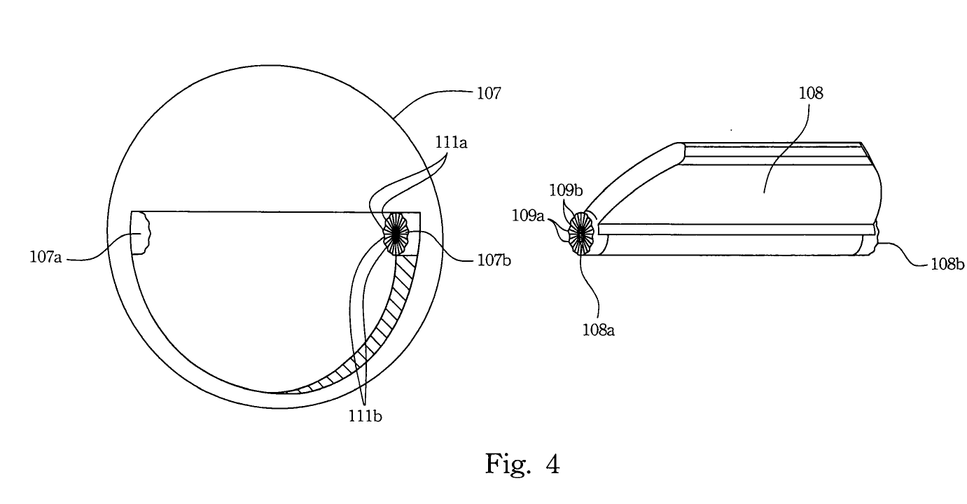

FIG. 4 illustrates an exploded view of the knob as illustrated in FIG. 3. The knob consists of the disc member 107 and the handle member 108. The handle member 108 is pivotally connected with the circular disc member 107 and both two members as a combination are rotatably connected on the outer support surface 102a of the body portion 102. In order to enable the handle member 108 to be temporarily positioned relative to the disc member 107, the handle member 108 has two wave-shaped end surfaces (108a, 108b) and the disc member 107 has two wave-shaped end surfaces (107a, 107b). When the wave-shaped end surface 108aengages the wave-shaped end surface 107a and the wave-shaped end surface 108b engages the wave-shaped end surface 107b, crests (109a, 111a) on one wave-shaped end surface engage corresponding troughs (109a, 111b) on the other wave-shaped end surface such that the handle member 108 can be positioned on the disc member 107. Each wave-shaped end surface has crests and troughs alternately arranged circularly (around a center of the end surface) thereon.

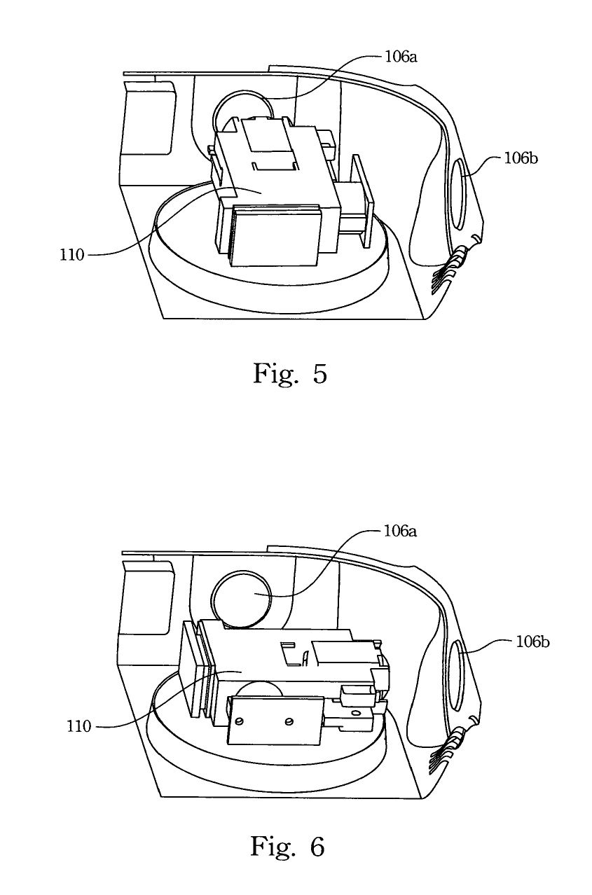

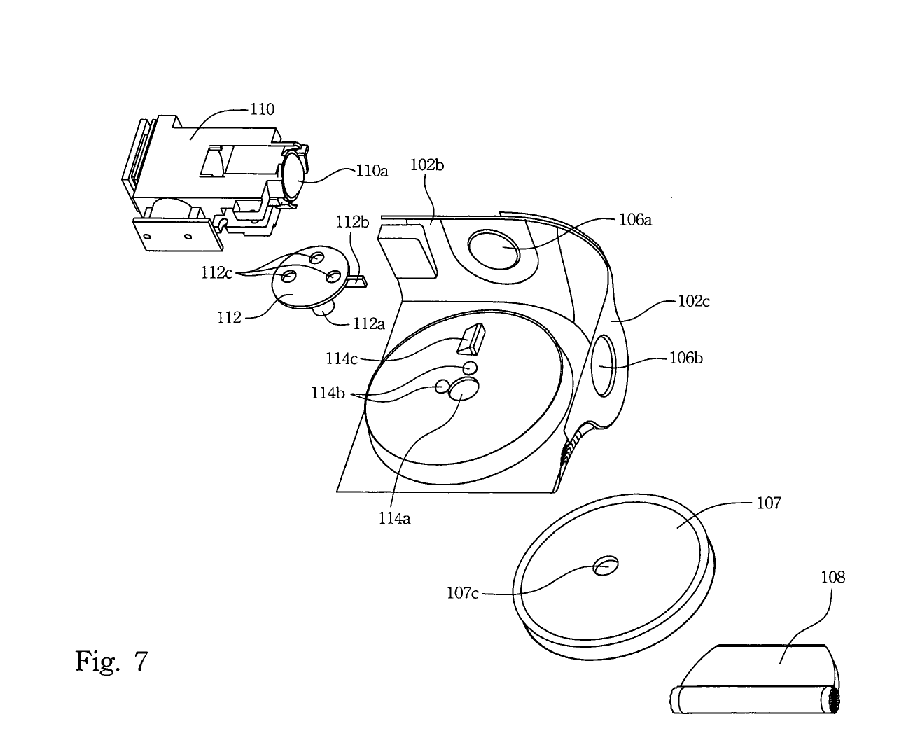

FIG. 5 and FIG. 6 respectively illustrate two different projection modes of a portable electronic device according to one preferred embodiment of this invention. When a projection head 110a of the projection module 110 is aligned with the projection window 106a (referring to FIG. 5 and FIG. 7), the handle member 108 is in the status as illustrated in view (c) of FIG. 3. When a projection head 110a of the projection module 110 is aligned with the projection window 106b (referring to FIG. 6 and FIG. 7), the handle member 108 is in the status as illustrated in view (a) or view (b) of FIG. 3. The projection windows (106a and 106b) can be made from any transparent materials (such as transparent glass).

FIG. 7 illustrates an exploded view of a projection module within the portable electronic device to detail how the projection module to be pivotally with the body portion. The body portion 102 in this embodiment is a hollow housing. A hinge member 112 has a disk member to support the projection module 110 thereon and a cylindrical rod 112a to be led through a hole 114a of a hollow housing. The cylindrical rod 112a is secured within a connection hole 107c of the disk member 107 such that the disk member 107, the hinge member 112 and the projection module 110 can be rotated simultaneously. The handle member 108 is pivotally connected with the circular disc member 107 (also referring to FIG. 4) to be rotated simultaneously with the disk member 107. The disk member of the hinge member 112 has three position holes 112c and a position rib 112b extending laterally from the disk member. The hollow housing of the body potion 102 has two convex members 114b and a block 114c. When the hinge member 112 is rotated by means of the cylindrical rod 112a, the convex members 114b engaging into the position holes 112c and/or the block 114c limiting the position rib 112b would enable the projection head 110a of the projection module 110 to be readily aligned with the projection windows 106a or 106b on two immediately-adjacent housing walls 102a/102a of the hollow housing. The block 114c stops the position rib 112b such that the hinge member 112 would not be over rotated. When one of the convex members 114b engages into one of the position holes 112c, the hinge member 112 is temporarily positioned and the projection head 110a of the projection module 110 is simultaneously aligned with the projection windows 106a or 106b.

According to discussed embodiments, the present invention provides a portable electronic device with projection function such that a presenter can perform a presentation without carrying an extra projector. In addition, the projection direction and angle can be adjusted towards a desired one so as to achieve an optimum projection effect.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An image projector, comprising:
a body portion comprising a hollow housing, the hollow housing comprising two immediately-adjacent housing walls, each of the two housing walls having a projection window;
a projection module rotatably connected to and within the hollow housing and having a projection head for projecting an image; and
a knob rotatably connected on an outer support surface of the hollow housing and connected to the projection module, whereby the knob is operable to rotate the projection head to selectively align with one of the two projection windows.

2. The image projector of claim 1, wherein the knob comprises a disc member and a handle member, the handle member is pivotally connected with the disc member to be selectively laid against the disc member or form an included angle between the handle member and the disc member.

3. The image projector of claim 2, wherein the disc member and handle member each have a wave-shaped end surface to engage each other, and crests on one of the two wave-shaped end surfaces engage troughs on the other of the two wave-shaped end surfaces.

4. The image projector of claim 3, wherein the crests and troughs are alternately arranged circularly on the two wave-shaped end surfaces.

5. The image projector of claim 1, wherein the projection window is made from transparent materials.

6. A portable electronic device, comprising:
a body portion comprising a hollow housing, the hollow housing comprising two immediately-adjacent housing walls, each of the two housing walls having a projection window;
a display portion pivotally connected with the hollow housing;
a projection module rotatably connected to and within the hollow housing and having a projection head for projecting an image; and
a knob rotatably connected on an outer support surface of the hollow housing and connected to the projection module, whereby the knob is operable to rotate the projection head to selectively align with one of the two projection windows.

7. The portable electronic device of claim 6, wherein the knob comprises a disc member and a handle member, the handle member is pivotally connected with the disc member to be selectively laid against the disc member or form an included angle between the handle member and the disc member.

8. The portable electronic device of claim 7, wherein the disc member and handle member each have a wave-shaped end surface to engage each other, and crests on one of the two wave-shaped end surfaces engage troughs on the other of the two wave-shaped end surfaces.

9. The portable electronic device of claim 8, wherein the crests and troughs are alternately arranged circularly on the two wave-shaped end surfaces.

10. The portable electronic device of claim 6, wherein the projection window is made from transparent materials.
